(19) United States
(12) Patent Application Publication
(10) Pub. No.: US 2001/0014944 A1
(43) Pub. Date: Aug. 16, 2001

(54) Data communication device

(75) Inventors: Toshiaki Ibi, Kawasaki (JP); Takumi Kishino, Kawasaki (JP); Shigeru Hashimoto, Kawasaki (JP); Koken Yamamoto, Kawasaki (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: FUJITSU LIMITED, Kawasaki (JP)

(21) Appl. No.: 09/817,020

(22) Filed: Mar. 27, 2001

Related U.S. Application Data
(63) Continuation of application No. PCT/JP99/00601, filed on Feb. 10, 1999.

(30) Foreign Application Priority Data
Sep. 29, 1998 (JP) 10-275286

(51) Int. Cl. H04L 9/00

(52) U.S. Cl. 713/183; 380/252; 380/2

(57) ABSTRACT

There is provided a data communication device for transmitting input data to a host device, comprising: a sampling unit for sampling the input signal corresponding to the input operation at every prescribed timing cycle; a transmitter for transmitting data corresponding to the level of the sampled input signal to a host device; and a dummy signal generator for generating a dummy signal and laying the dummy signal over the input signal during the time period other than the sampling period. Even in the case of wiretapping of the input signal, the dummy signal that is unrelated to the input operation will thereby be detected along with the input signal. Theft of the data corresponding to the input signal can be prevented because the wiretapper will be unable to distinguish which is the input signal.

### BACKGROUND OF THE INVENTION

1. Field of the Invention

The present invention relates to a data communications device for transmitting input secret data such as a personal identification number to a host device, and more particularly to a data communication device that can prevent the theft of this secret data.

2. Description of the Related Art

Data communication devices, such as cash dispensers and automatic teller machines, are generally known as terminals used for withdrawing money from banks or the like. The data communication device is connected to a host device by communications lines and communicates various types of data to and from the host device.

When this type of data communication device is used, it is necessary to input a user's particular secret data, such as a personal identification number, in order to ensure security.

For the so-called electronic money systems that have become more common in recent years, communication with the host device is made possible by inserting a prescribed card or the like and inputting a personal identification number to the data communication device that is the terminal.

Normally, means for inputting various types of data, including secret data, include buttons or touch panels established on a screen.

FIGS. 12 are drawings to explain the principle of a touch panel. FIG. 12A shows a top view of the touch panel and FIG. 12B is a drawing showing the principle of the touch panel. In FIG. 12A, the horizontal direction across the screen is the x axis and the vertical direction is the y axis. Prescribed data are input by pressing a number or character displayed at a position defined by the x and y coordinates.

As shown and FIG. 12B, a voltage plane 2 to which voltage is applied from a power source 5 is established below the cover 1 disposed on the upper surface of the touch panel. The voltage of this voltage plane 2 gradually declines from the power input side to ground. Furthermore, a measuring plane 3 for measuring the potential of the voltage plane is established below the voltage plane 2.

With this type of constitution, the voltage plane 2 is brought into contact with the measuring plane 3 when a prescribed position on the screen is pressed with a finger from above the cover 1, and the potential of the contact position is measured by a voltmeter 4 connected to the measuring plane 3. In other words, the voltage plane 2 is shown with an equivalent circuit as shown in FIG. 12C. When the voltage plane 2 is pressed down, the voltmeter 4 measures the resistance divided potential.

The potential of the contact position on the measuring plane 3 is measured in both the direction of the x axis and the y axis and the number or letter displayed at the position pressed is recognized as data from a matrix of each of the potentials.

Consequently, a problem is that there is a risk of data such as someone's personal identification number being stolen by a third party who has contrived wiretapping operations to detect this potential inside the data communication device. This secret data being stolen by another person is a significant drawback to security.

### SUMMARY OF THE INVENTION

Consequently, in view of the abovementioned problem, it is an object of the present invention to provide a data communication device that prevents data theft and has a further improved security level.

In order to achieve the abovementioned object, the data communication device relating to the present invention is a data communication device for transmitting input data to a host device and comprises: a sampling unit for sampling the input signal corresponding to the input operation at every prescribed timing cycle; a transmission controller for transmitting data corresponding to the level of the sampled input signal to a host device; and a dummy signal generator for generating a dummy signal and overlaying the dummy signal on the input signal during the time period other than the sampling timing period.

Even in the case of wiretapping of the input signal, the dummy signal that is unrelated to the input operation will thereby be detected along with the input signal. Theft of the data corresponding to the input signal can be prevented because the wiretapper will be unable to distinguish which is the input signal.

In order to make it more difficult to distinguish the input signal and a dummy signal, it is preferable that the level, pulse width, and output resistance of the dummy signal be randomized by using random numbers, for example.

Also, it is preferable that the initial values of the random numbers be established on the basis of the timing of a prescribed event that occurs asynchronously, such as the reception of a prescribed command or the access to a prescribed address on the internal storage disk.

The data communication device relating to the present invention preferably further comprises: a memory for storing a code key for encrypting and transmitting data; and a housing unit with wiring connected to the memory applied around the inner surface, in order that breakage of the wiring will delete the code key stored in the memory and bring operation of the data communication device to a halt.

Accordingly, even in the event of wiretapping operations of the dummy signal generator in order to analyze the dummy signal, those wiretapping operations will break the wiring and stop the power supplied to the memory, thereby halting all operations of the data communication device and making theft impossible.

### BRIEF DESCRIPTION OF THE DRAWINGS

FIG. 1 is a block diagram of the constitution of the data communication device in accordance with an embodiment of the present invention;

FIGS. 2 are drawings to explain the timing chart of the dummy signal;

FIG. 3 is a block diagram of the constitution of the resistance-varying unit;

FIG. 4 is a diagram of the assembly of the security case;

FIG. 5 is a development drawing of the wiring film 104a to be affixed to the inner surface of the front case 101;

FIG. 6 an enlarged view of portion A in FIG. 5;

FIG. 7 is a drawing showing the situation of the wiring film 104a affixed to the inner surface of the front case 101;

FIG. 8 is a development drawing of the wiring film 104b mounted on the bottom surface of the rear case 102;

FIG. 9 is a drawing showing the mounting of the wiring film 104b on the bottom surface of the rear case 102;

FIG. 10 is a drawing showing the connection of the wiring pattern P;

FIG. 11 is a drawing showing the relationships between the positions of the security switch 45 and the screws 106 during assembly of the security case; and

FIGS. 12 are drawings for explaining the principle of the touch panel.

### DESCRIPTION OF THE PREFERRED EMBODIMENTS

The embodiments of the present invention are explained below. However, the technical scope of the present invention is not limited by these embodiments.

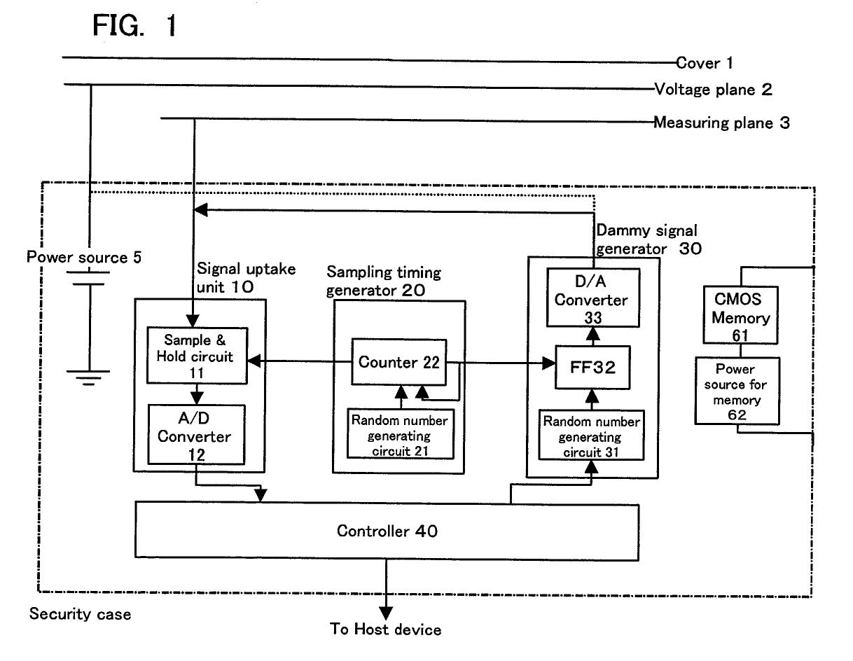

FIG. 1 is a block diagram of the data communication device in accordance with an embodiment of the present invention. The data communication device in FIG. 1 comprises a voltage plane 2 below the cover 1 of the touch panel and a measuring plane 3 therebelow, and a prescribed voltage is applied to the voltage plane 2 from the power source 5. Furthermore, the measuring plane is connected to a signal uptake unit 10 for taking up the input signal having the potential (level) corresponding to the position on the voltage plane 2 that is touched by a finger.

The signal uptake unit 10 takes up the input signal according to the sampling timing signal which is input at prescribed intervals from the sampling timing signal generator 20. Normally, the time for one press of the touch panel by a user is 300 milliseconds to one second. Accordingly, the prescribed interval is a shorter period of time (for example, about 100 milliseconds) than this time period.

In FIG. 1, the signal uptake unit 10 comprises a sample and hold circuit 11 and an A/D converter 12. The input signal is input to the sample and hold circuit 11. The sample and hold circuit 11 samples the input signal each time the sampling timing signal is input and holds that level until the next input of the sampling timing signal. The signal output from the sample and hold circuit 11 is output to the A/D converter 12 and converted to a digital signal.

The digital signal output from the A/D converter 12 is input to the controller 40. The controller 40 comprises a CPU, ROM, RAM, and communications port (not shown), for example. Based on the program housed in ROM, the CPU performs software processes on the digital signal. Specifically, the CPU controls the recognition of the input digital signal as the number and character data pressed on the panel, the encryption of that number and character data, and the transmission of that encrypted data to the host device over communications lines.

The embodiment relating to the present invention comprises a dummy signal generator 30, for generating a dummy signal with a randomly varied potential or level at times other than the sampling timing. This dummy signal is laid over the input signal. With such construction, even when a third party contrives wiretapping operations of the input signal to detect the potential of the measuring plane, it is impossible to distinguish which is the level of the true input signal and theft of the input signal becomes impossible, because a dummy signal with a randomly varied level is laid over the input signal.

On the other hand, because the dummy signal is not laid over the input signal at the sampling timing, the signal uptake unit can acquire the true input signal without the dummy signal overlaying it. Consequently, the controller 40 acquires the data corresponding to the position on the voltage plane 2 that is touched by a finger.

In FIG. 1, the dummy signal generator 30 comprises a random number generating circuit 31 for generating random numbers, a flip-flop (FF) 32, and a D/A converter 33. The random number generating circuit 31 generates random numbers comprising a prescribed number of bits at the prescribed timing. The random numbers are input to the flip-flop (FF) 32. The flip-flop (FF) 32 then outputs the random numbers to the D/A converter 33 at every sampling timing signal input from the sampling timing signal generator 20 at the prescribed intervals. The D/A converter 33 outputs a dummy signal with a level corresponding to the input random numbers. A dummy signal having a random level can be generated in this manner.

Furthermore, the pulse width of the dummy signal may also be randomly varied. Specifically, the period of the sampling timing signal is randomly varied. The sampling timing signal generator 20 for that purpose is shown in FIG. 1.

In FIG. 1, the random number generating circuit 21 in the sampling timing signal generator 20 generates random numbers comprising a prescribed number of bits at the prescribed timing. The random numbers generated are input to the counter 22. The counter 22 counts up from that value and outputs the sampling timing signal at the overflow (carry) timing. The period of the sampling timing signal can be randomly varied in this manner.

Also, the sampling timing signal is used to reset the counter 22 itself; when the sampling timing signal is input to the counter 22, the random number input from the random number generating circuit 21 is loaded and the counter starts counting up again.

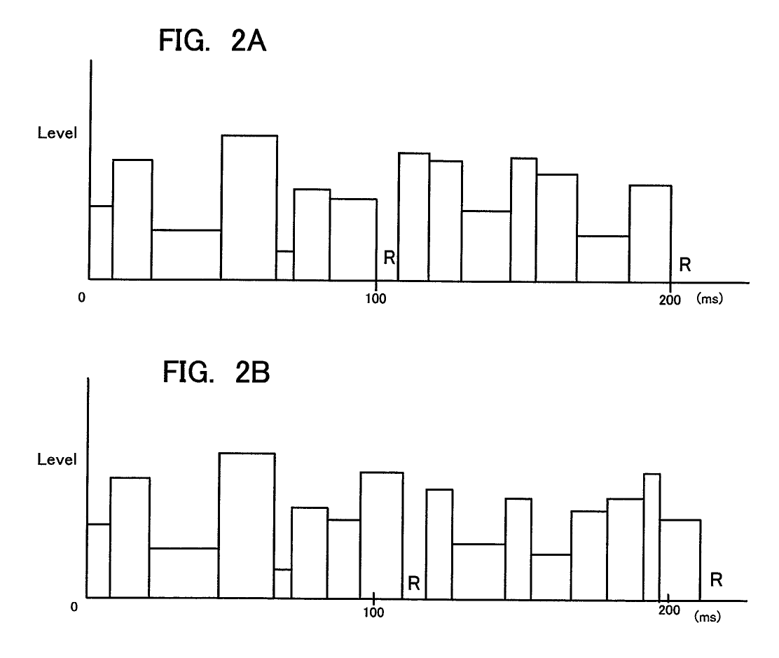

FIGS. 2 are drawings to explain the timing chart for the dummy signal. In FIGS. 2, sampling timing is shown by the signal R. In both FIGS. 2A and 2B, dummy signals with randomly varied levels and pulse widths are generated at times other than sampling timing. In FIG. 2A, sampling timing occurs periodically every 100 milliseconds, but in FIG. 2B, there is some shifting (jitter) of the period according to the pulse width of the dummy signal. In other words, in the case where the dummy signal is generated every 100 milliseconds, the generation of the dummy signal is forcibly reset and the input signal is sampled, as in FIG. 2A. In FIG. 2B, however, the input signal is sampled after the end of the generation of the dummy signal after the 100 milliseconds.

In order that the initial values for the random numbers in the random number generating circuit 31 in the dummy signal generator 30 and the random number generating circuit 21 in the sampling timing signal generator 20 do not become fixed, it is preferable that the initial values of the random numbers be varied by a prescribed asynchronous factor. For example, a slight shift (jitter) of the speed of rotation number of revolutions of the storage disk (not shown) in the data communication device can be used. In other words, access to a prescribed address on the storage disk after the device starts up is detected. That detected timing differs slightly according to the shift in the speed of rotation of the storage disk. Therefore, setting the initial values of the random numbers according to that timing can vary the initial values of the random numbers. The initial values of the random numbers may also be varied using the timing of the reception of a prescribed command by the data communication device.

Furthermore, the abovementioned dummy signal generator 30 has internal resistance. Consequently, detecting this internal resistance value makes it possible to distinguish the times at which the dummy signal is and is not output from the dummy signal generator 30. In the present embodiment, therefore, resistance-varying means for randomly varying the output resistance of the dummy signal may also be included in the dummy signal generator 30.

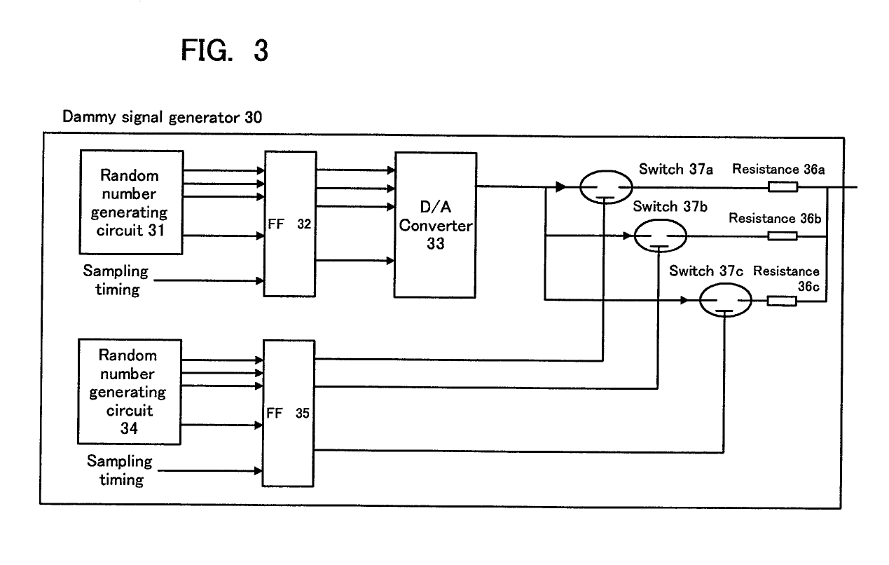

FIG. 3 is a block diagram of the constitution of the dummy signal generator 30 including resistance-varying means. In FIG. 3, a separate random number generating circuit 34 and separate flip-flop (FF) 35 are established in addition to the random number generating circuit 31 and the flip-flop (FF) 32. Also, a plurality of switches at 37a, 37b, 37c, for turning on and off the plurality of resistors 36a, 36b, 36c disposed in parallel, are established on the output side of the D/A converter 33.

Based on the random numbers from the separate random number generating circuit 34, the separate flip-flop (FF) 35 supplies output signals with randomly varied levels to each of the switches 37 at the sampling timing. Consequently, each switch 37 is turned randomly on and off based on the output signal.

The switches 37 corresponding to the plurality of resistors 36 disposed in parallel are randomly turned on and off. As a result, the output resistance of the dummy signal output from the D/A converter 33 of the dummy signal generator 30 is also randomly varied. Consequently, because the resistance varies even during dummy signal output, it becomes impossible to distinguish when the dummy signal is and is not output and security is improved.

Furthermore, in the present embodiment of this invention, the abovementioned elements, as explained below in detail, are contained within a security case having a printed wiring film applied to the inner surface thereof, in order to improve the security level further and in order to prevent wiretapping operations of the various abovementioned elements disposed within the data communication device (See the dash dotted line in FIG. 1). Moreover, in the following explanation, the various abovementioned elements are disposed on a single board (Hereinafter referred to as “security board”).

A CMOS memory 61, for storing the code key necessary when encrypting data with the encryption program, and a power supply 62 for that memory are also disposed on the security board (see FIG. 1).

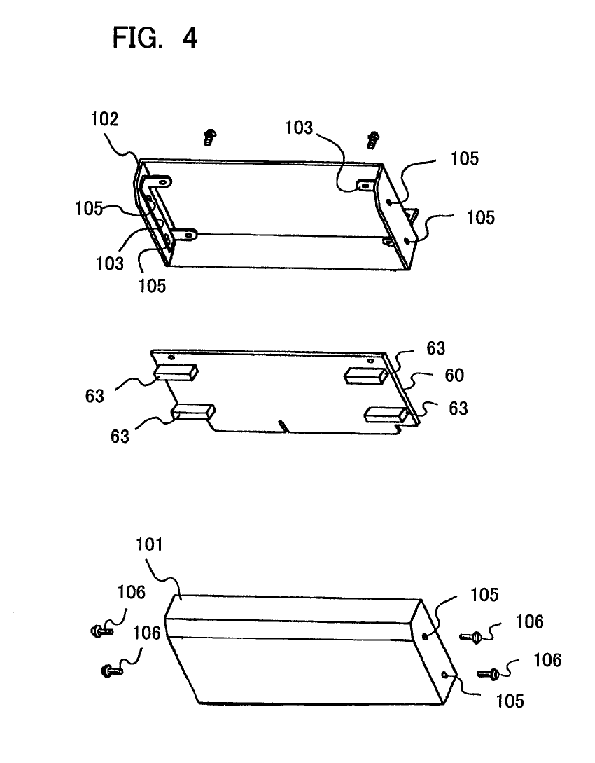

FIG. 4 shows an assembly view of the security case. This security case comprises sections of sheet metal, and is constituted of a front case 101 and a rear case 102. A mounting bracket 103 for mounting the security board 60 is welded to the rear case 102. Also, security switches 63 are mounted on the four corners of the security board. Preferably, microswitches are used for the security switches 63.

To assemble the security case, a printed pattern wiring film 104 is applied to the inner surfaces of the front case 101 and the rear case 102. Next, the necessary wiring is assembled and the security board 60 is mounted. After that, the front case 101 and the rear case 102 are attached by screws 106 through the screw holes 105.

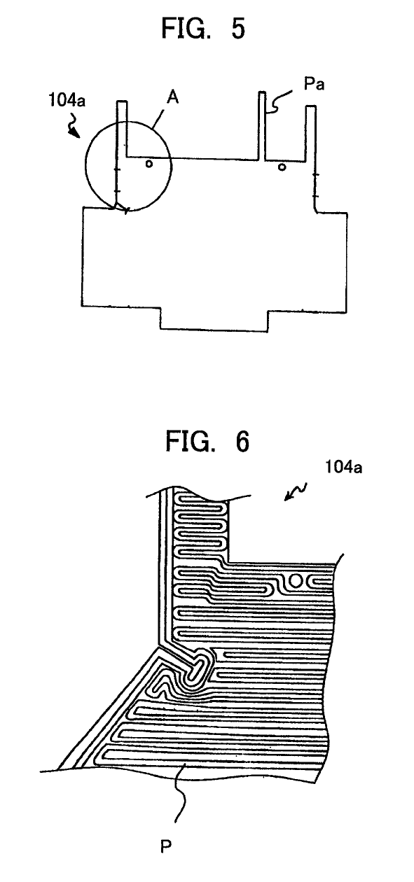

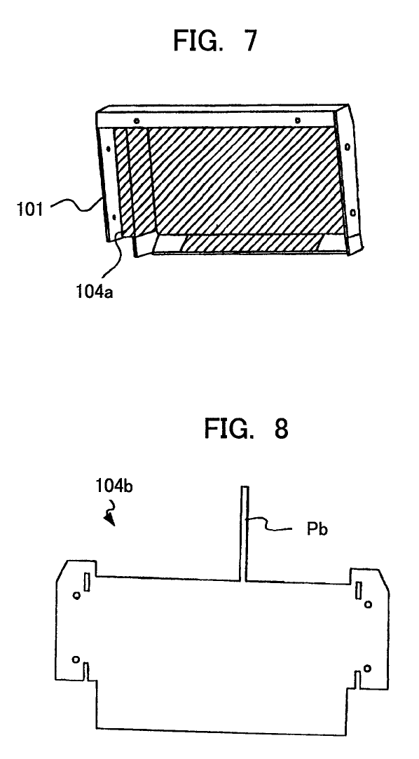

The attachment of the printed pattern wiring film (hereinafter referred to as “wiring film”) 104 is explained. FIG. 5 is a development drawing of the wiring film 104a mounted on the inner surface of the front case 101. FIG. 6 shows a detail of portion A in FIG. 5. FIG. 7 is a drawing showing the attachment of the wiring film 104a to the inner surface of the front case 101. A single long wire is formed in a fine pattern on the wiring film 104a (wiring pattern P). This type of wiring film 104a is formed in the open shape of the front case 101. The form of the wiring film 104a can be easily created from the form drawing of the front case 101. Next, the wiring film 104a is bent to fit the form of the front case 101. Adhesive is used to mount the wiring film 104a. Both ends of the wiring pattern P become the leads Pa connected to the wiring pattern of the other portion.

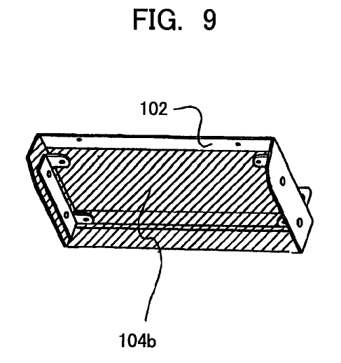

FIG. 8 is a development drawing of the wiring film 104b mounted on the bottom surface of the rear case 102. FIG. 9 is a drawing showing the mounting of the wiring film 104b on the bottom surface of the rear case 102. The structure of the wiring film 104b is the same as that discussed above; the wiring pattern P differs according to the form of the wiring film 104, but does comprise a single long wire. The form of this wiring film 104b is the same as the form of the bottom surface of the rear case 102. The wiring film 104b is formed in such a shape, and then bent to fit the form of the rear case 102. Adhesive is used to mount the wiring film 104b. Also, both ends of the wiring pattern P become the leads Pb for connecting to the wiring pattern of the other section.

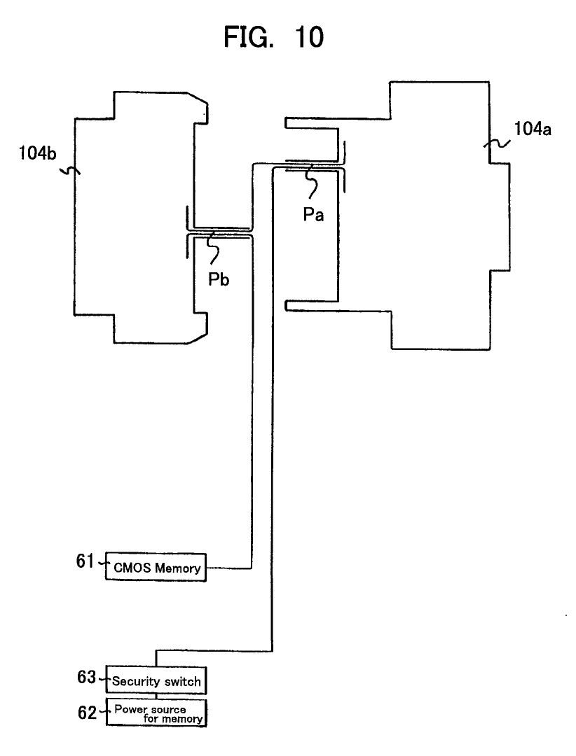

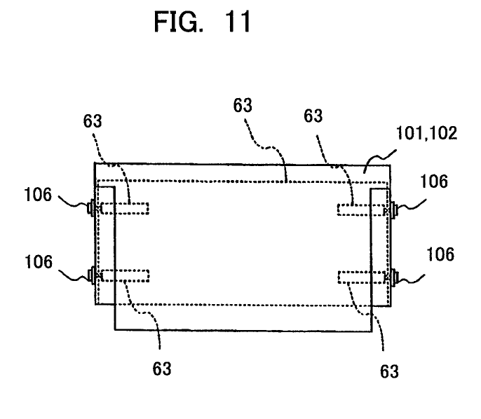

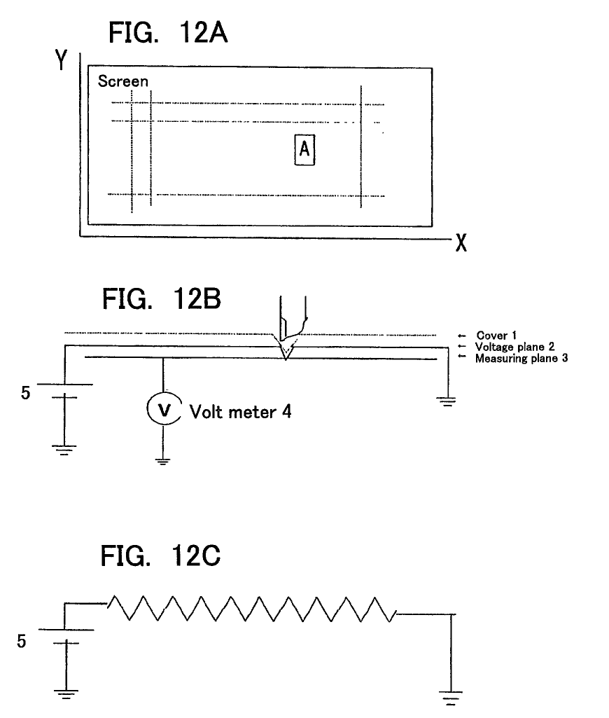

FIG. 10 is a drawing showing the connected state of the wiring pattern P. As shown in the drawing, the wire extending from the memory power supply 62 passes through the security switch 63 and connects the leads Pa and Pb of both wiring films 104a and 104b, thereby connecting and terminating at the CMOS memory 61. As a result, the power supply to the CMOS memory 61 is interrupted if any portion of the wiring pattern P is broken.

The security switch 63 is explained next. FIG. 11 is a drawing showing the relationships between the positions of the security switch 45 and the screws 106 when the security case is assembled. The front case 101 and rear case 102 are attached by four screws 106. With the screws 106 screwed into the screw holes 105, the ends of the screws 106 are in contact with the security switches 63 established on the security board 40. In this state, it becomes possible for power to be supplied from the memory power supply 62 to the CMOS memory 61. When the screws 106 are removed, the security switch 63 is opened and the power supply to the CMOS memory 61 is interrupted. Also, these security switches 63 are connected in series (not shown). Therefore, if any one of the security switches 63 is opened, the power supply to the CMOS memory 61 is interrupted.

The security of operations of this type of security case of explained next. For example, consider the case where a hole is drilled in the security case and wiretapping operations are performed. When the hole is drilled in the security case, the wiring film 104 applied to the inside of the security case will have the wiring broken at some point. The power supply from the memory power supply 62 to the CMOS memory 61 is thereby cut off and the code key stored in the CMOS memory 61 is deleted. When the code key is deleted, the device stops functioning and theft becomes impossible.

Next, consider the case where the security case is opened and the code key is stolen. It is necessary to remove the screws 106 in order to open the security case. However, because the ends of the screws are in contact with the security switches, removing the screws 106 will open the security switches 63. The power supply from the memory power supply 62 to the CMOS memory 61 is thereby cut off and the code key stored in the CMOS memory 61 is deleted. When any one of the four screws is removed and the code key is deleted, the device stops functioning as in the case above and theft becomes impossible. In this manner, theft can be prevented by having the CMOS memory 61 that stores the code key housed within the abovementioned security case, because the code key in the CMOS memory 61 is deleted when wiretapping operations are performed.

Moreover, it is also possible to have a regular nichrome wire attached to the inside of the security case, instead of the wiring film 104, and to have the code key deleted based on the breakage of the nichrome wire. It is also possible to have the wiring film 104 printed on a metal substrate in the same shape as the security case and affixed inside the security case.

In the embodiment relating to the present invention, a dummy signal is laid over the input signal from the measuring plane 3, but is not limited to that and may also be directly supplied to the voltage plane 2. (See the dotted line extending from the dummy signal generator 30 in FIG. 1) In this case as well, the dummy signal is laid over the input signal and the same effects are achieved as with the embodiment discussed above.

Also, in the embodiment relating to the present invention, a resistive film touch panel is shown as the input means, but the input means are not limited to that so long as the input means are such that the signal level varies according to the input operation.

As explained above, the present invention has a dummy signal with an arbitrarily varied level laid over an input signal at times other than the sampling timing for the input signal corresponding to the input operation. Consequently, it becomes impossible to distinguish the level of the input signal from outside the device and security is improved.

Furthermore, security can be still further improved by randomly varying the sampling timing, the pulse width of the dummy signal, and the output resistance of the dummy signal.

Also, theft is prevented and security improved by housing the elements necessary for security, such as the dummy signal generator, within a security case so that the device stops functioning when wiretapping operations from outside are detected.

Consequently, the data communication system relating to the present invention can be used as an ATM device for a bank or as a terminal in an electronic money system where a high-level of security is necessary.

The scope of protection of the present invention is not limited to the above embodiments and covers the invention defined in the appended claims and its equivalents.

What is claimed is:

1. A data communication device for transmitting input data to a host device, comprising:
a sampling unit for sampling an input signal corresponding to an input operation at every prescribed timing cycle;
a transmission controller for transmitting data corresponding to the level of the sampled input signal to the host device; and
a dummy signal generator for generating a dummy signal and overlaying the dummy signal on the input signal during the time period other than the sampling timing period.

2. The data communication device according to claim 1, wherein the level of said dummy signal is randomly varied in the intervals other than said timing.

3. The data communication device according to claim 2, wherein said data signal generator causes the level of said dummy signal to be randomly varied using random numbers.

4. The data communication device according to claim 2, wherein the pulse width of said dummy signal varies randomly.

5. The data communication device according to claim 4, wherein said data signal generator causes the pulse width of said dummy signal to be randomly varied by using random numbers.

6. The data communication device according to claim 4, wherein said prescribed period varies according to the variation of the pulse width of said dummy signal.

7. The data communication device according to claim 1, wherein the output resistance of said dummy signal varies randomly.

8. The data communication device according to claim 7, wherein said dummy signal generator causes varies said output resistance to be randomly varied by using random numbers.

9. The data communication device according to claim 3, wherein the initial values of said random numbers are established based on the occurring timing of a prescribed event that occurs asynchronously.

10. The data communication device according to claim 9, wherein said prescribed event is the receipt of a prescribed command or access to a prescribed address on the internal storage disk.

11. The data communication device according to claim 1, further comprising:
a memory for storing a code key for encrypting and transmitting said data; and
a housing unit for housing the memory and said dummy signal generator, in which wires connected to the memory are laid around to the inner surface thereof;
wherein the breakage of the wires results in the deletion of the code key stored in the memory and the stoppage of operation of the data communication device.
